(19) United States
(12) Patent Application Publication
(10) Pub. No.: US 2013/0107507 A1
(43) Pub. Date: May 2, 2013

(54) Remote Control Floating Fishing Light

(71) Applicants: Danny R. Tucker, Russellville, AR (US); Christopher J. Ostrander, Lawrence, KS (US); Derick R. Schweppe, Lawrence, KS (US); Scott B. Van Horn, Dover, AR (US)

(72) Inventors: Danny R. Tucker, Russellville, AR (US); Christopher J. Ostrander, Lawrence, KS (US); Derick R. Schweppe, Lawrence, KS (US); Scott B. Van Horn, Dover, AR (US)

(21) Appl. No.: 13/609,483

(22) Filed: Sep. 11, 2012

Related U.S. Application Data
(60) Provisional application No. 61/628,255, filed on Oct. 27, 2011.

(51) Int. Cl. F21L 4/00

(52) U.S. Cl. 362/190

(57) ABSTRACT

A floating light (10) to aid a night time fisherman. The floating light (10) is maneuverable by remote control (20). The floating light (10) includes a battery operated directional light (13) mounted onto a floating vessel. The directional light (13) is directed at the surface of the water or just above the surface so that a fisherman is able to illuminate a desired area when fishing at night to safely illuminate obstacles. The floating light (10) desirably operates at “casting distance” and has a smooth low profile. The floating light (10) may include a motor driven propeller (14) and rudder (15) operably connected to a radio remote control receiver (45). A radio remote control transmitter (27) operable by the fisherman transmits signals to the receiver (45) on the floating light (10) to direct the motion of the floating light (10).

### CROSS-REFERENCE TO RELATED APPLICATIONS

This application claims the benefit of U.S. Provisional Patent Application No. 61/628,255 filed Oct. 27, 2011, which is incorporated herein by reference in its entirety.

### STATEMENT REGARDING FEDERALLY SPONSORED RESEARCH OR DEVELOPMENT

Not applicable.

### BACKGROUND OF THE INVENTION

1. Field of the Invention

The present invention relates to a floating light to aid a nighttime fisherman, and in particular, to such a light that is maneuverable by remote control and which is directional.

2. Brief Description of the Related Art

When fishing at night, a fisherman must be aware of obstacles that are either safety hazards or that might interfere with casting and retrieving the fishing line. These obstacles include rocks, logs, vegetation, stumps and the like. These obstacles can be seen and avoided by the use of suitable illumination. However, lights that are hand held or mounted to the fishing boat are limited in their range and may not be able to effectively illuminate obstacles at normal casting distance. Lights in the boat also attract insects. It is thus desirable to provide a way to allow the fisherman to illuminate areas at or near the surface of the water that are some distance from the fishing boat and the fisherman.

The limitations of the prior art are overcome by the present invention as described below.

### BRIEF SUMMARY OF THE INVENTION

The present invention is directed to a floating light to aid a nighttime fisherman. The light is maneuverable by remote control and is directional. The floating light comprises a light mounted onto a floating vessel which is propellable and maneuverable by means such as a propeller driven by an electric motor and a remote controlled rudder. The floating light may be referred to herein as a “boat.” The light source may any of various types, such as LED or fluorescent. The light desirably operates on battery power for several hours at a time. The light is directed at the surface of the water or just above the surface so that a fisherman is able to illuminate a desired area when fishing at night. The light thus allows the fisherman to safely illuminate obstacles, such as rocks, logs, vegetation, stumps and the like. The vessel desirably operates by radio frequency (RF) remote control at “casting distance,” i.e., 30-40 feet from the fisherman's boat. The vessel is preferably provided with a smooth low profile to avoid wind resistance and allow for greater ease of maneuverability.

The vessel includes means for propelling the vessel, means for maneuvering the vessel and a battery power supply, all operably connected to a radio remote control receiver. A low battery indication light is optionally displayed on the vessel so that the operator has notice before the battery expires.

A radio frequency (RF) remote control transmitter operable by the fisherman transmits signals to a receiver on the vessel to direct the motion of the vessel on the surface of the water. The remote control may be manually operable by the fisherman. In one embodiment, the control may be operated manually by holding the remote control in one hand and operating the controls with the operator's thumb. In another embodiment, the radio remote control transmitter may be provided with a foot operated control, similar to a mouse pad, to allow the fisherman to operate the vessel without requiring the use of the fisherman's hands. The transmitter may also be provided with a belt loop, so that the fisherman may operate the transmitter manually if desired.

These and other features, objects and advantages of the present invention will become better understood from a consideration of the following detailed description of the preferred embodiments and appended claim in conjunction with the drawings as described following:

### BRIEF DESCRIPTION OF THE SEVERAL VIEWS OF THE DRAWINGS

FIGS. 1A-1G show an embodiment of a remote control. FIG. 1A is a left front perspective view, FIG. 1B is a left side elevation view, FIG. 1C is a right side elevation view, FIG. 1D is a top plan view, FIG. 1E is bottom plan view, FIG. 1F is rear elevation view, and FIG. 1G is a front elevation view.

FIGS. 2A-2F show an embodiment of a floating light. FIG. 2A is a rear elevation view, FIG. 2B is a left rear perspective view, FIG. 2C is a left elevation view, FIG. 2D is a right bottom perspective view, FIG. 2E is a top plan view, and FIG. 2F is a bottom plan view.

FIGS. 3A-3D illustrate a floating light having a directional light. FIG. 3A is a right front perspective view of an embodiment of a floating light having a directional light. FIG. 3B is a right front perspective view of an embodiment of a remote control for use with the floating light of FIG. 3A. FIG. 3C is a top plan view of the remote control of FIG. 3B. FIG. 3D is a top plan schematic of an array of light emitting diodes (LED's) for use with a plurality of light directing chambers.

FIG. 4 is an exploded right front perspective view of the floating light of FIG. 3A.

FIG. 5 is a bottom perspective view of the LED array of FIG. 3D.

FIG. 6 is a top perspective view of the directional light and plurality of light directing chambers of FIGS. 4 and 6.

FIG. 7 is a left rear perspective view of the interior of the hull of the floating light of FIG. 4.

FIG. 8 is an exploded right front perspective view of the remote control of FIG. 3B.

FIGS. 9A-9I are flowcharts illustrating the operation of an embodiment of a floating light and remote control. FIG. 9A illustrates powering the device on. FIG. 9B illustrates operation of the remote control. FIG. 9C illustrates operation of the X-axis motion of the joystick. FIG. 9D illustrates operation of the Y-axis motion of the joystick. FIG. 9E illustrates operations of the servo and speed control functions. FIGS. 9F-9H illustrate setting the operation of the LED's. FIG. 9H illustrates the function of setting the direction of the light from the LED's. FIG. 9I illustrates the low battery warning.

### DETAILED DESCRIPTION OF THE INVENTION

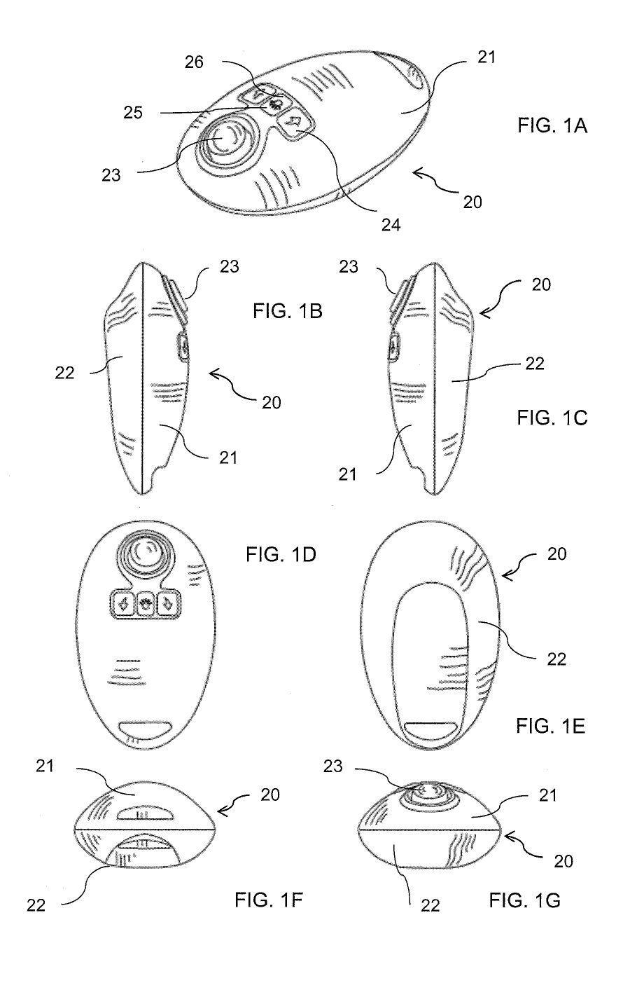

With reference to FIGS. 1A-9I, the preferred embodiments of the present invention may be described. The present invention is directed to a floating light 10 to aid a nighttime fisherman. The light is 10 maneuverable by remote control and the light is directional. The floating light 10 comprises a directional light 13 mounted onto a floating vessel which is propellable and maneuverable by means such as a propeller driven by an electric motor and a remote controlled rudder. The electric motor may be either a brushed or brushless type. A motor providing a no load speed of 17,000 rpm and a load speed of 10,000 rpm when used with a 7.4 volt power supply would be suitable. The light source may be any of various types, such as LED or fluorescent. The floating light 10 desirably operates on battery power for several hours at a time. The floating light 10 is directed at the surface of the water or just above the surface so that a fisherman is able to illuminate a desired area when fishing at night. The floating light 10 thus allows the fisherman to safely illuminate obstacles, such as rocks, logs, stumps and the like. The floating light 10 desirably operates by radio remote control at “casting distance,” i.e., 30-40 feet from the fisherman's boat. The floating light 10 is preferably provided with a smooth low profile to avoid wind resistance and allow for greater ease of maneuverability.

The floating light 10 includes means for propelling the floating light 10, means for maneuvering the floating light 10 and a battery power supply 41, all operably connected to a radio remote control receiver. The battery power supply 41 is desirably a lithium-polymer (Li-Po) type for high power density per weight. A T4 volt system is suitable. A low battery light is optionally displayed on the vessel so that the operator has notice before the battery power supply expires.

A radio frequency (RF) remote control transmitter housed in a remote control 20 operable by the fisherman transmits signals to an RF remote control receiver 45 housed within the floating light 10 to direct the motion of the floating light 10 on the surface of the water. The remote control 20 may be manually operable by the fisherman. In one embodiment, the remote control 20 may be provided with a foot operated control, similar to a mouse pad, to allow the fisherman to operate the floating light 10 without requiring the use of the fisherman's hands. The remote control 20 may also be provided with a belt loop (not shown), so that the fisherman may operate the remote control manually if desired.

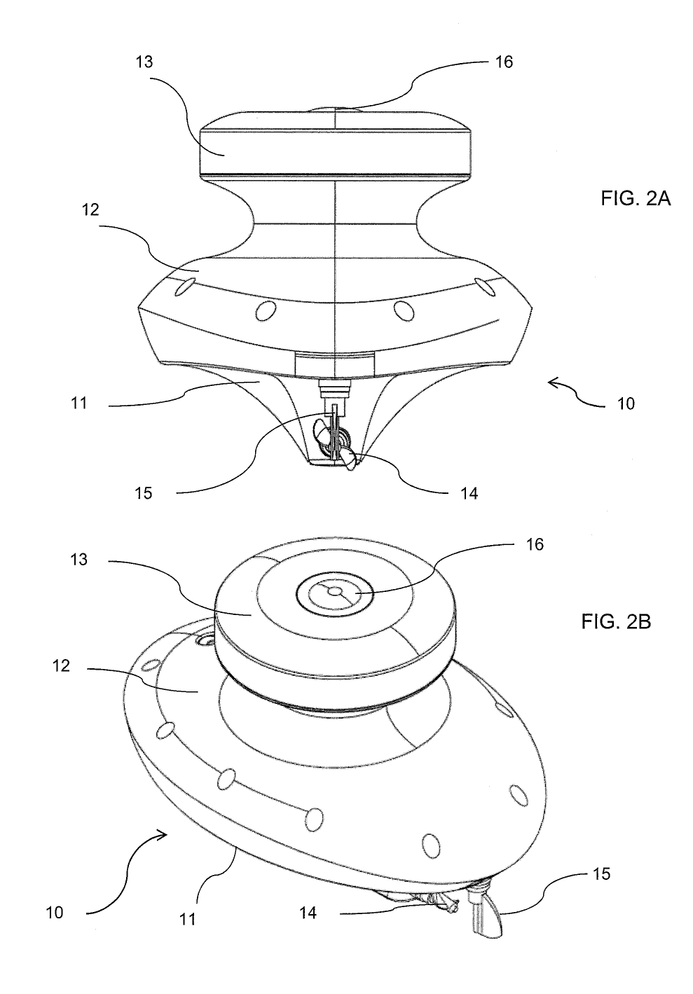

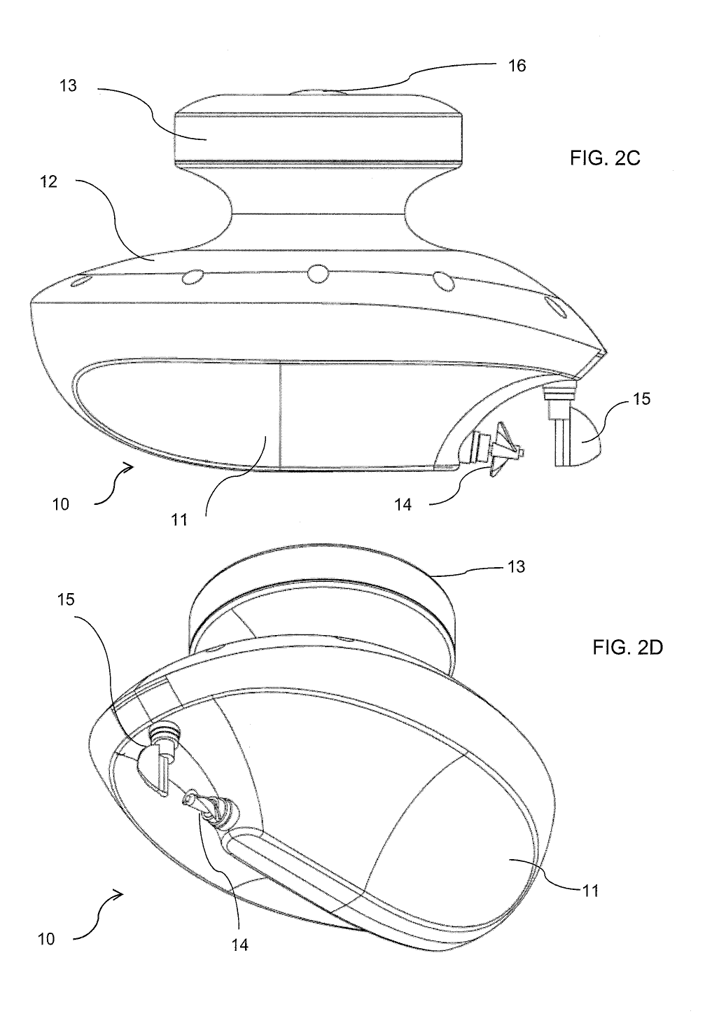

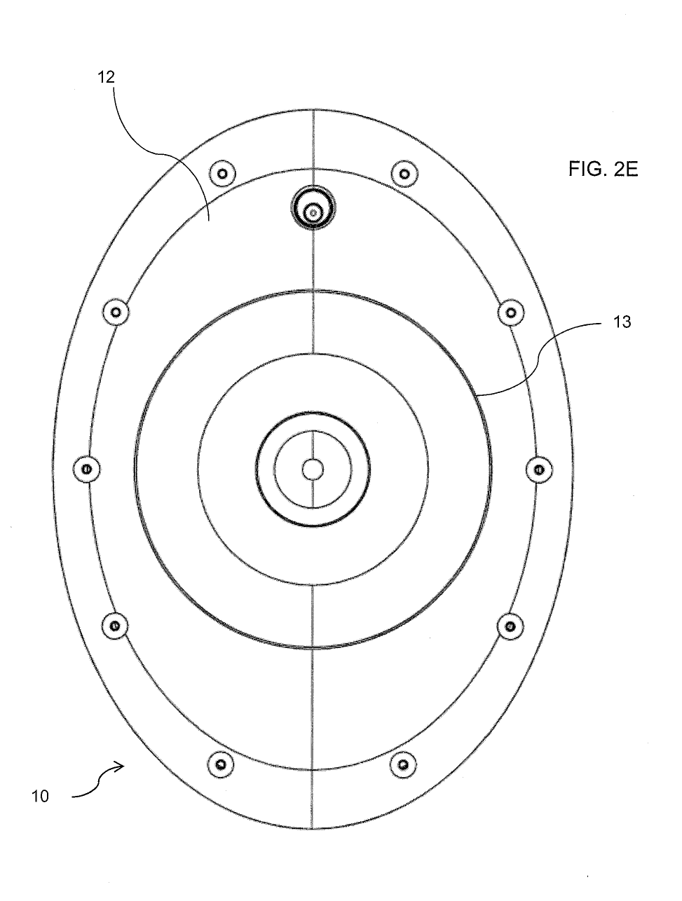

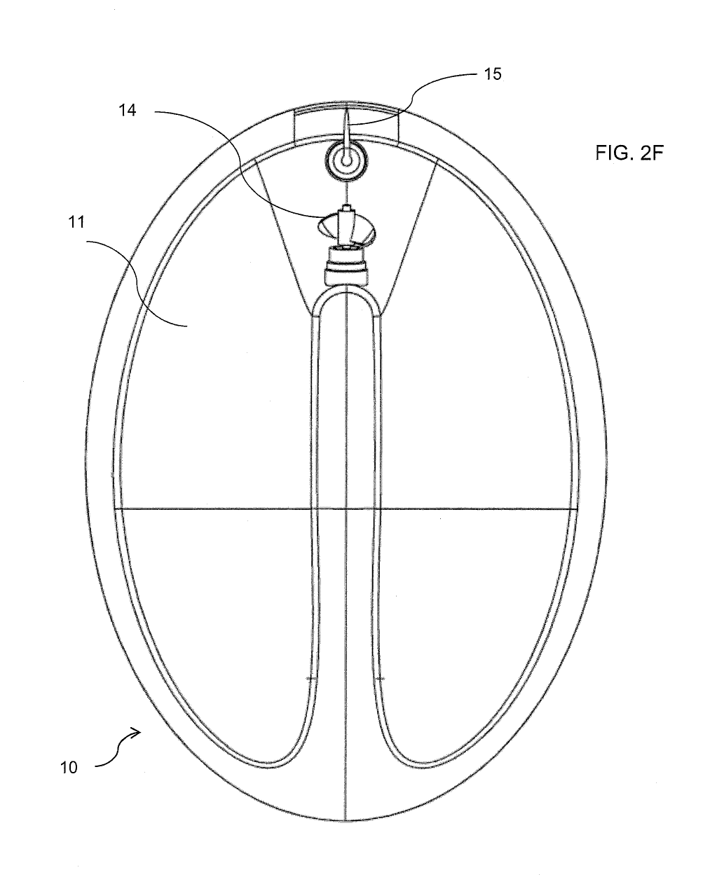

FIGS. 2A-2E illustrate a particular embodiment of a floating light 10 of the present invention. The floating light 10 comprises a floating vessel, which is desirably provided with a streamlined hull 11 for ease of maneuverability of the floating light 10 through the water as well as efficient low resistance movement to save on battery power. The hull 11 accommodates some of the internal components that provide the propulsion, steering and power functions for the floating light 10 as describe more fully below. The floating light 10 also comprises a floating vessel that is also desirably provided with a smooth low profile upper deck 12 for low wind resistance. The upper deck 12 also provides protection for the internal components and may include a rubber sealed plug (not shown) for recharging an internal battery power supply 44, described more fully below. A balancing charger 40 specifically designed for Li-Po batteries and usable with a standard wall outlet, a car battery or a boat battery is desirable. The floating light 10 is also provided with a propeller 14 and rudder 15. A directional light 13 is positioned above the upper deck 12. A sealed on/off switch 16 may be provided on the top of the directional light 13. The hull 11, upper deck 12 and directional light 13 are desirably constructed of a plastic material for durability, water resistance and light weight. Likewise, the rudder 15 is preferably plastic, while the propeller 14 is preferably nylon. The material from which the floating light 10 is constructed should also be ultraviolet light resistant. Appropriate gaskets and other water sealing materials and techniques as well known in the art may be applied to or between different parts of the floating light 10 to ensure water resistance. Non-plastic parts, for example metallic parts, are desirably made of corrosion resistant materials.

The floating light 10 is operated by a remote control 20 described more particularly with respect to FIGS. 1A-1 G and FIG. 8. The remote control 20 is provided with an upper casing 21 and a lower casing 22 that together comprise a housing for holding the electronic components of a radio frequency (RF) remote control transmitter 27 as described in more detail below. The upper casing 21 also provides a location for an array of operational controls, including a joystick 23, rotate counter-clockwise button 24, rotate clockwise button 25 and bright/dim mode button 26. The joystick 23, rotate counter-clockwise button 24, rotate clockwise button 25 and bright/dim mode button 26 are desirably provided with an overmolded cover 28 for water resistance. The overmolded cover 28 should allow free movement of the joystick 23 while maintaining watertightness. The joystick 23 may be of various types known in the art, such as a 2-axis style or a laptop keyboard style. The joystick 23 provides speed and direction signals to the floating light 10. The remote control 20 houses the RF remote control transmitter 27 powered by batteries 29, such as standard AAA types. The lower casing 22 is desirably provided with a door 50 to allow access to the interior of the housing in order to replace the batteries 29. The remote control 20 desirably includes an LED disposed under a watertight clear plastic lens (not shown) on the upper casing 21 for a low battery indicator.

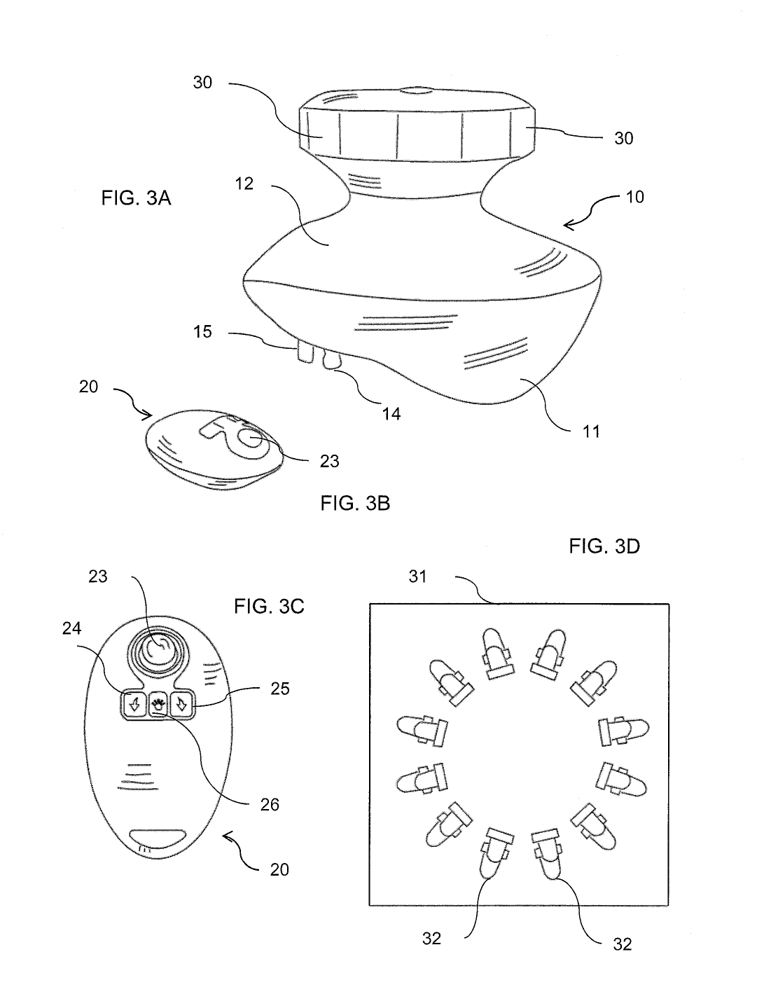

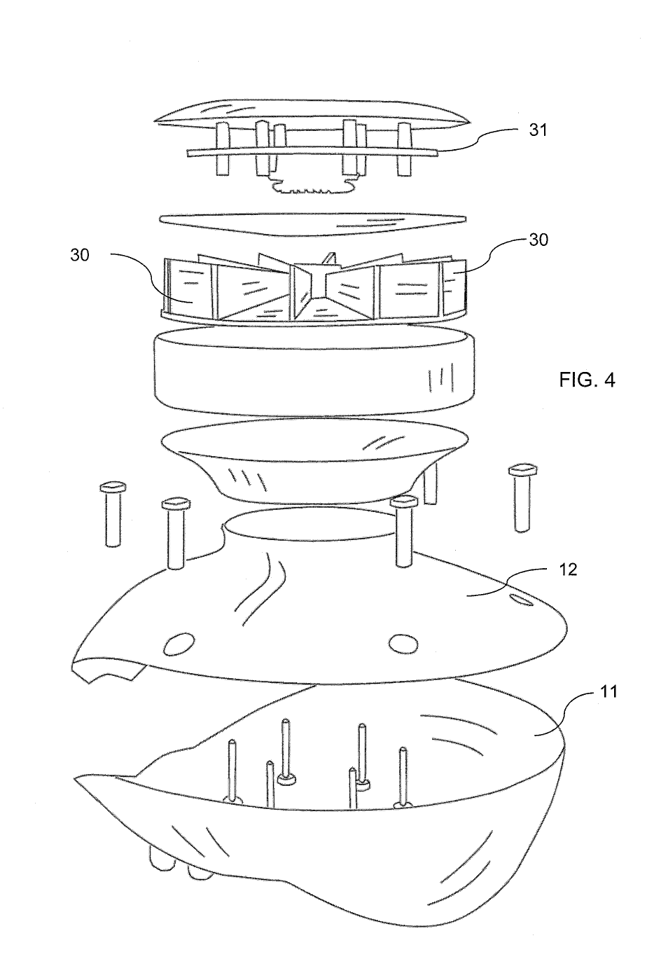

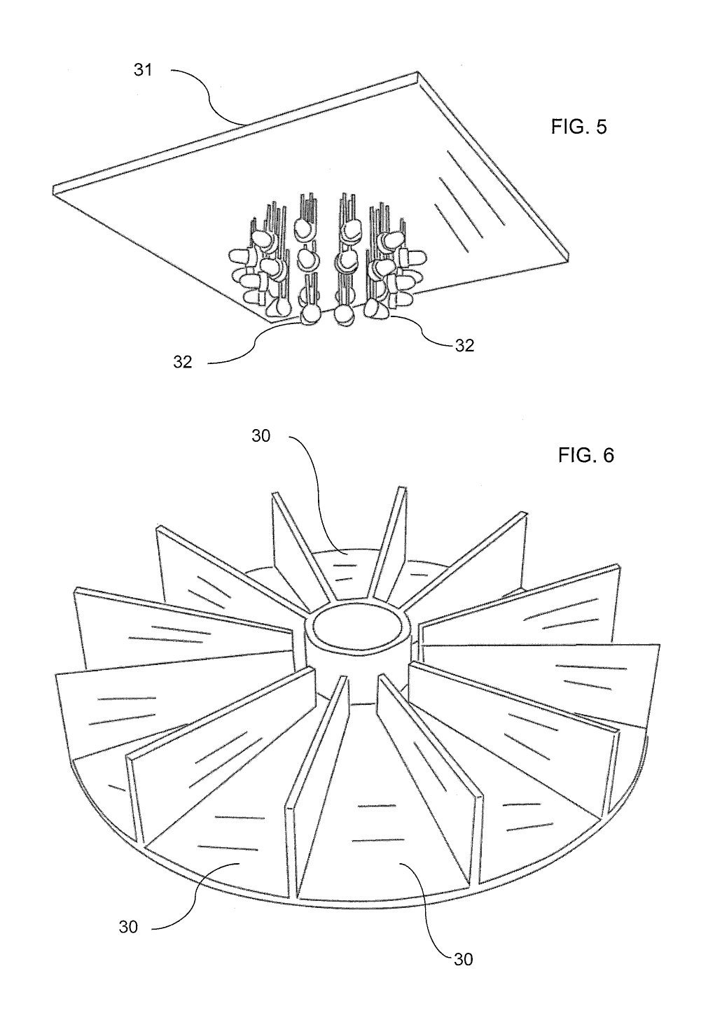

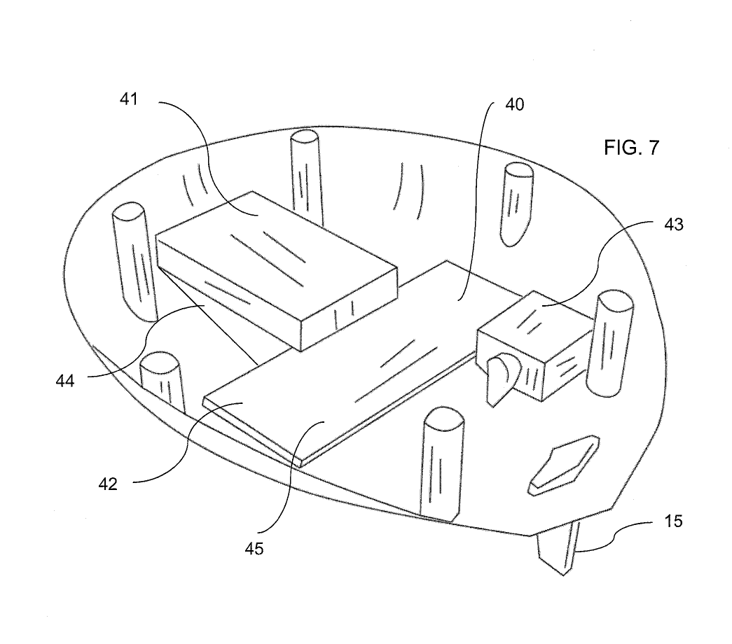

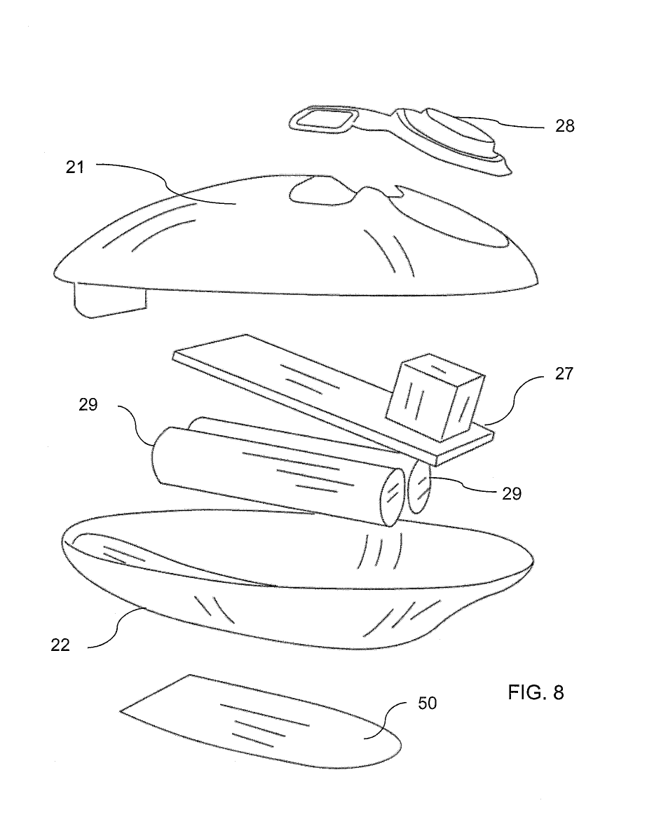

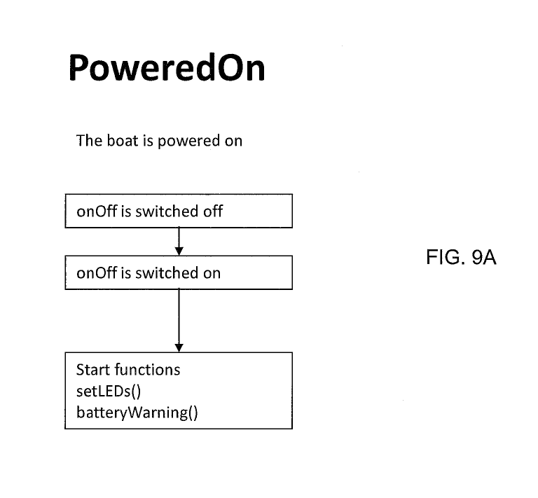

The directional light 13 may be described in more detail with respect to FIG. 3A-6. The directional light 13 comprises a plurality of chambers 30 disposed radially in a plane that may be horizontal, or, in some embodiments, the chambers 30 may be disposed so as to direct light below a horizontal plane. Each chamber 30 is closed at the top, bottom and sides, but with a clear surface directed radially outwardly. The interior top, bottom and sides of each chamber 30 are desirably reflective, such as by means of a metallic coating, to maximize the amount of light directed outwardly. An array of lights, such as an array 31 comprising a plurality of LEDs (light emitting diodes) 32, is disposed so that at least one LED 32 is located in each of the plurality of chambers 30. In one embodiment, two LEDs 32 are disposed in each chamber 30. Thus, one of the two LEDs may be illuminated for a dim light and both LEDs may be illuminated for bright light. The LEDs may also be selectively dimmed. LEDs capable of being dimmed through pulse width modulation circuitry would be suitable in the practice of the present invention. Selected LEDs 32 may be illuminated in a particular radial direction to provide a beam of light in that particular radial direction without the necessity of maneuvering the floating light 10 itself. In one embodiment, LEDs 32 may be disposed in twelve radial directions to allow flexibility in determining the direction of the beam of light. Remote control operation of the directional light 13 is explained more fully below. The top of the directional light 13 may be provided with an on/off button 16 for providing power to the floating light 10. The on/off button 16 is desirably provided with an overmolded cover for water resistance. The LEDs 32 are desirably of GaN type emitting a white light of 3000 mcd (3 candlepower each) luminous intensity.

It is desirable that the LEDs 32 in five (5) adjacent chambers 30 be illuminated at a time. In dim mode, only five (5) LEDs 32 in five (5) chambers 30 may illuminated, while in bright mode, ten (10) LEDs 32 in the same five (5) chambers 30 may be illuminated. Shifting between dim and bright mode is accomplished by means of the dim/bright mode button 26 on the remote control 20. Likewise, the direction of the beam of light from the LED's 32 may be selected by means of the rotate counter-clockwise button 24 and rotate clockwise button 25 on the remote control 20. By operating these two controls, the LEDs 32 of adjacent groups of five chambers 30 are selected and shifted either clockwise or counterclockwise, one chamber 30 at a time.

The internal components of the hull 11 may be described with respect to FIG. 7. The internal components as well as the other components of the floating light 10 should comprise as low a total weight as possible for maximum buoyancy and must be distributed so that the floating light 10 is level at rest and self-righting. The internal components will desirably include electronic components, including a charging unit 40 with balance charging circuitry to balance a 2 cell Li-Po battery 41. The electronic components will also desirably include an electronic speed controller with reverse 42. The electronic components will be operationally connected to the charging plug and to a servo 43 to control the rudder 15 and thus the direction of the floating light 10. The servo 43 desirably has torque of 3.0 kg-cm at 4.8 volts for adequate steering. The battery power supply 41 is desirably rechargeable and comprises a 2 cell Li-Po battery of 7.4 volts. A motor 44 for driving the propeller 14 desirably has a no load of speed of 16,000 rpm. The electronic components also include an RF remote control receiver 45, preferably operating at 2.4 GHz and functioning at a range of up to 50 m. The electronic components, including speed controller 42, charging unit, 40 and RF receiver are all operatively connected to the motor 44, servo 43, battery 41, recharging plug and on/off switch 16.

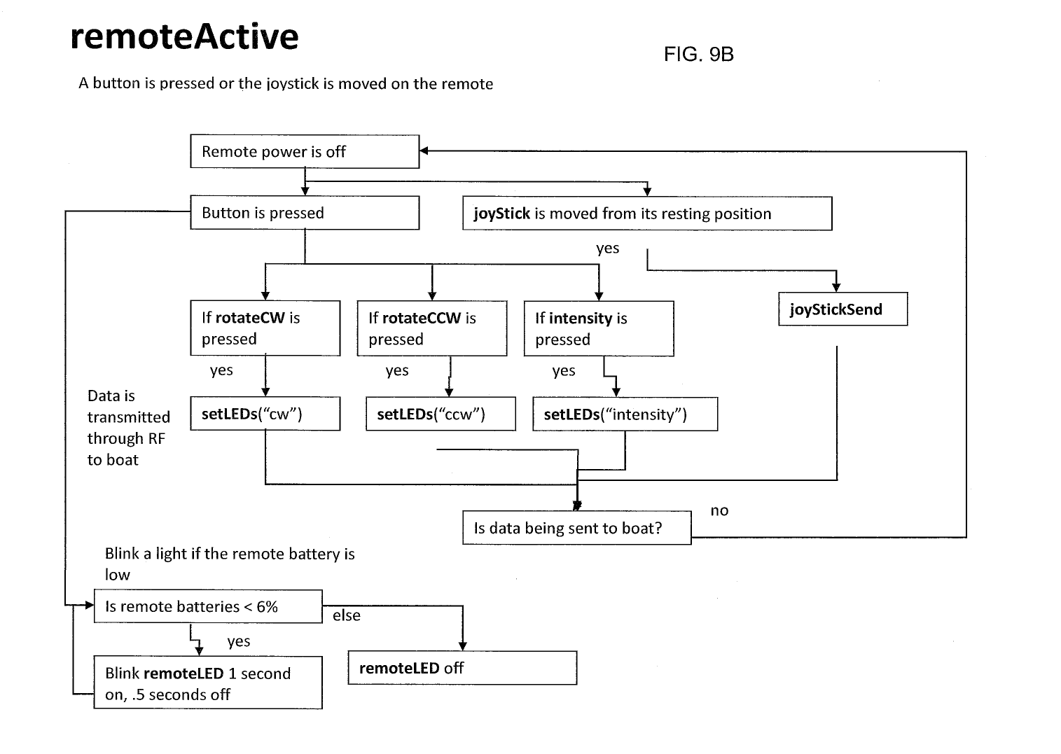

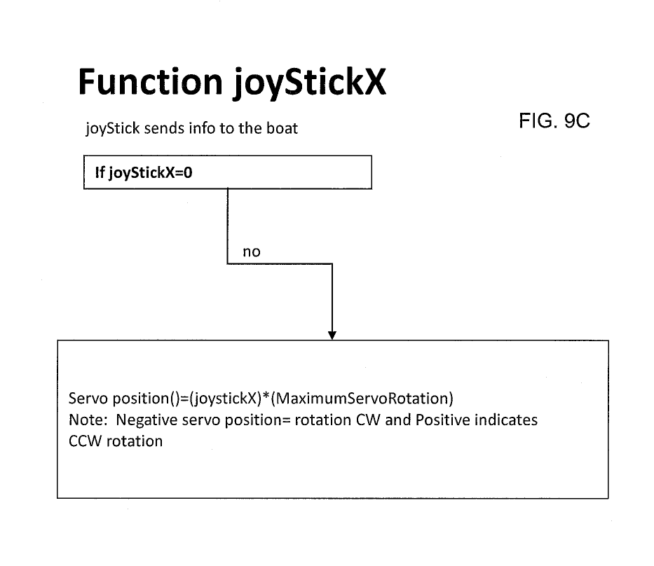

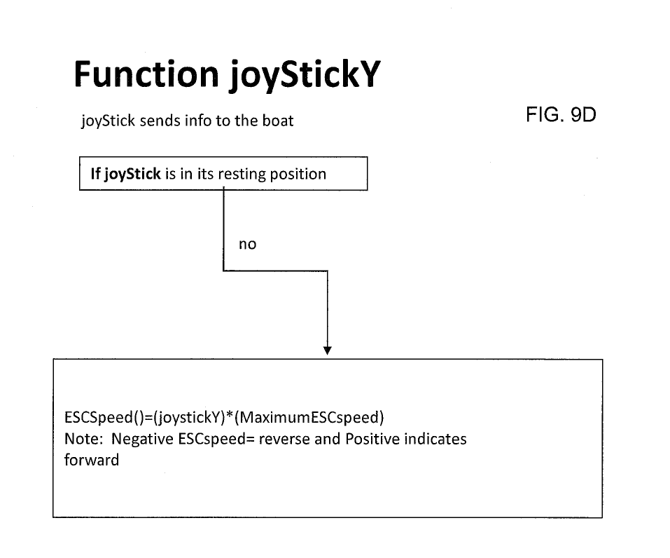

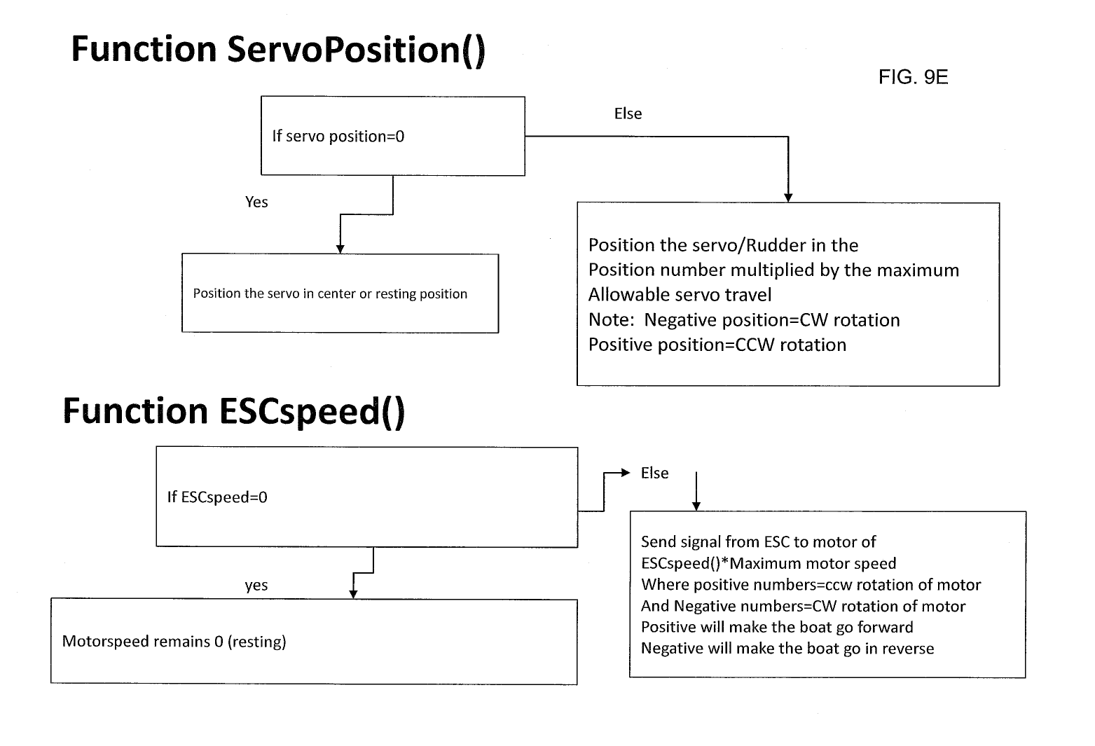

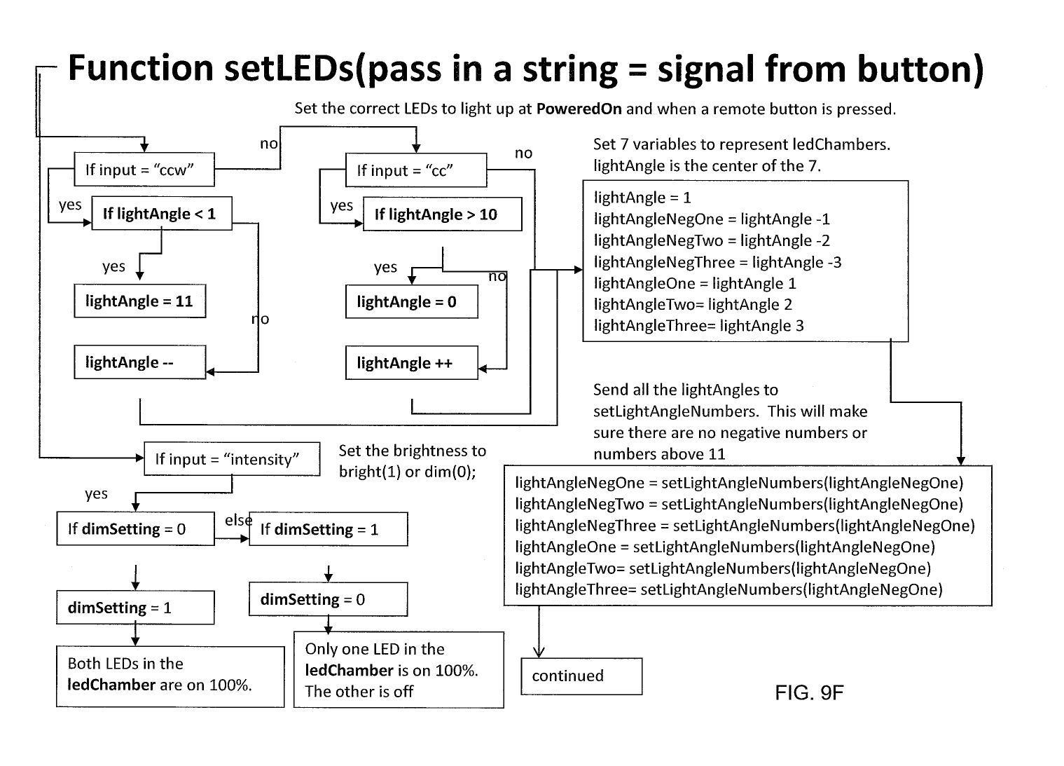

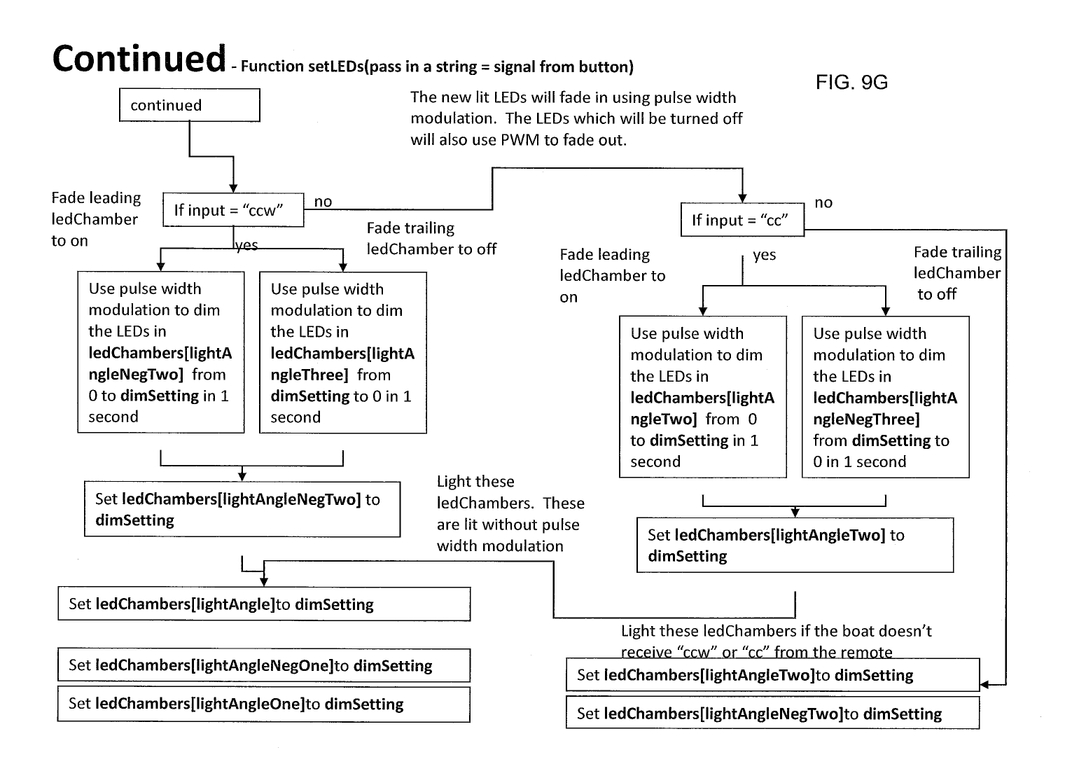

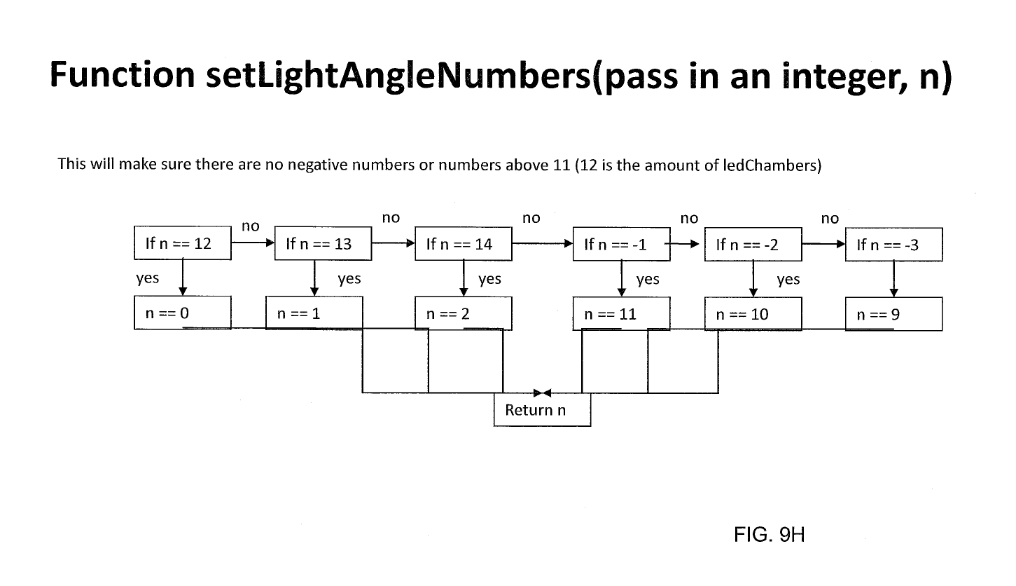

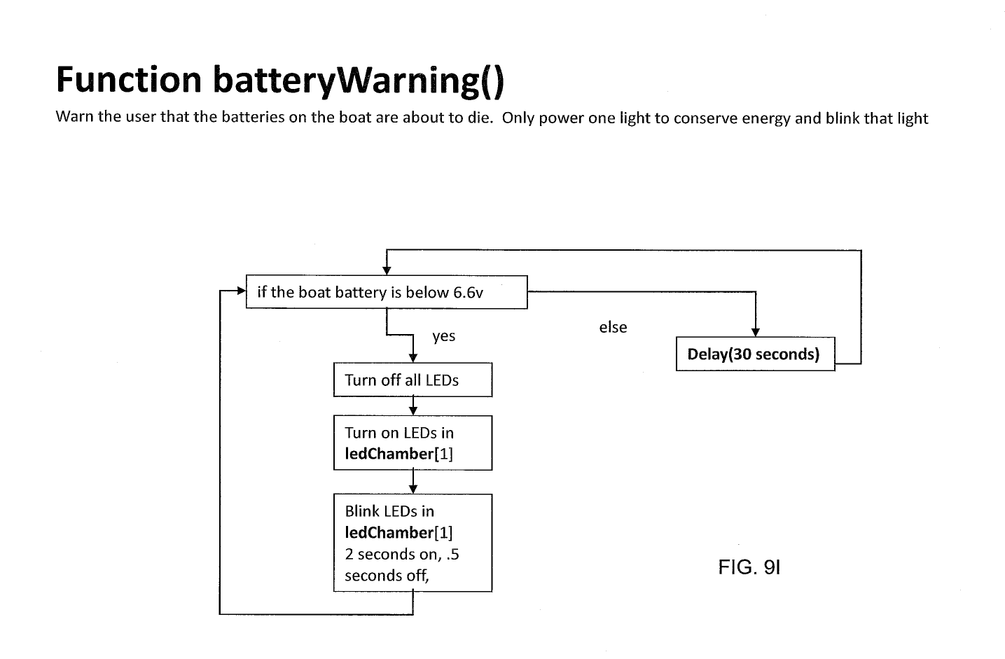

FIGS. 9A-9I provide detailed flowcharts of the operation of the controls and functions of an embodiment of the floating light 10 and remote control 20. In FIGS. 9A-9I, motion in a clockwise direction may be identified as “CW” while motion in a counter-clockwise direction may be identified as “CCW.” FIG. 9A illustrates powering the floating light 10 on and starting the functions of setting the LEDs 32 and the low battery warning. FIG. 9B illustrates operation of the radio frequency (RF) remote control 20, including using the joystick 23 to send maneuvering data to the floating light 10 and directional data to the directional light 13. FIG. 9C illustrates operation of the X-axis motion of the joystick 23. In this embodiment, the motion of the joystick 23 with a position to the extreme left registers −1, a midway position registers 0, and a position to the extreme right registers +1, while positions midway between the extreme positions register +/−0.5. A “0” position centers the servo 43 and thus the rudder 15. A signal to rotate clockwise translates to a negative position of the servo 43. A signal to rotate counter-clockwise translates to a positive position of the servo 43. FIG. 9D illustrates operation of the Y-axis motion of the joystick 23. Similarly to the X-axis, the motion of the joystick 23 with a position to the extreme forward registers −1, a midway position registers 0, and a position to the extreme rear registers +1, while positions midway between the extreme positions register +/−0.5. A positive position equates to a forward speed of the floating light 10, while a negative position equates to a reverse speed of the floating light 10. FIG. 9E illustrates functions operating the servo 43 and speed control 42 in more detail. FIGS. 9F-9H illustrate setting the operation of the LEDs 32. The setting of variables to represent seven LED chambers 30 is illustrated. In setting the angles corresponding to the LEDs 32 to be illuminated, this function assures that no negative numbers or numbers above 11 are set. Pulse width modulation is used to fade the leading or trailing LEDs 32 in or out, respectively. FIG. 9H illustrates the function of setting the direction of the light from the LEDs 32 to ensure that no negative numbers or numbers above 11 are selected (based on an embodiment with 12 LED chambers 30. FIG. 9I illustrates the low battery warning function which blinks one LED 32 with the other LEDs 32 unpowered to conserve energy.

In operation, the fisherman/operator may maneuver a fishing boat to a fishing area. The fisherman may then direct the floating light 10 by the remote control 20 to a location convenient to the point where the fisherman intends to cast a line. After the floating light 10 has been positioned, the LEDs may be rotated to the correct angle to keep the light out of the fisherman's eyes. Alternatively, the direction of the LEDs may remain in one setting and the floating light 10 itself may be positioned where the light cast by the floating light 10 will not shine in the fisherman's eyes. The direction of the light may thus be set by the fisherman or altered as required to cast a light where the fisherman anticipates the need to illuminate obstacles or otherwise illuminate a point of interest.

The present invention has been described with reference to certain preferred and alternative embodiments that are intended to be exemplary only and not limiting to the full scope of the present invention. For example, the size of the floating light 10 may be scaled up or down and the weight and location of the components may be altered.

What is claimed is:

1. A remote control floating fishing light for operation by an operator, comprising:
a floating vessel,
means for propelling said floating vessel;
means for maneuvering said floating vessel;
a directional light mounted onto said floating vessel;
a radio remote control receiver operably connected to said means for propelling and said means for maneuvering;
a radio remote control transmitter operable by the operator to transmit a radio remote control signal to said radio remote control receiver to maneuver said floating vessel; and
a rechargeable battery power supply operably connected to said means for propelling, said means for maneuvering, said radio remote control receiver, and said directional light.

2. The fishing light of claim 1, wherein said means for propelling comprises an electric motor driving a propeller.

3. The fishing light of claim 1, wherein said means for maneuvering comprises a rudder.

4. The fishing light of claim 1, wherein said directional light comprises at least one light source selected from the group consisting of an LED and a fluorescent light.

5. The fishing light of claim 1, wherein said directional light is directed at or just above a water surface.

6. The fishing light of claim 1, wherein said radio remote control signal is receivable by said radio remote control receiver at a range of at least 40 feet.

7. The fishing light of claim 1, wherein said floating vessel comprises a smooth low profile to minimize wind resistance.

8. The fishing light of claim 1, further comprising a low battery indicator light disposed on said floating vessel for visually signaling to the operator that said battery power supply is near exhaustion.

9. The fishing light of claim 1, wherein said radio remote control transmitter is manually operable by the operator.

10. The fishing light of claim 9, wherein said radio remote control transmitter comprises a belt loop for disposing said radio remote control transmitter on a belt of the operator.

11. The fishing light of claim 9, wherein said radio remote control transmitter comprises a foot operated control.

12. The fishing light of claim 1, wherein said floating vessel comprises a streamlined hull.

13. The fishing light of claim 12, wherein said hull comprises an internal space to accommodate said means for propelling, said means for maneuvering, and said battery power supply.

14. The fishing light of claim 12, further comprising an upper deck.

15. The fishing light of claim 1, wherein said floating vessel further comprises a sealable plug operably connected to means for recharging said battery power supply.

16. The fishing light of claim 1, comprising ultraviolet resistant material.

17. The fishing light of claim 1, comprising means for water resistance.

18. The fishing light of claim 1, comprising corrosion resistant materials.

19. The fishing light of claim 1, wherein said radio remote control comprises a housing whereon operational controls are disposed.

20. The fishing light of claim 19, wherein said operational controls comprise a joystick, a rotate counter-clockwise button, a rotate clockwise button, and a bright/dim mode button.

21. The fishing light of claim 20, wherein said joystick, said rotate counter-clockwise button, said rotate clockwise button and said bright/dim mode button are protected by an overmolded cover for water resistance.

22. The fishing light of claim 20, wherein said joystick comprises a 2-axis style joystick.

23. The fishing light of claim 20, wherein said joystick comprises a laptop keyboard style joystick.

24. The fishing light of claim 20, wherein said radio control signals comprise speed and direction signals and wherein said joystick is operably connected to said radio remote control transmitter to provide said speed and direction control signals to said radio remote control receiver.

25. The fishing light of claim 24, wherein said directional light comprises a plurality of chambers disposed radially.

26. The fishing light of claim 25, wherein each of said plurality of chambers is closed at a respective top, bottom and sides having reflective surfaces and a clear surface directed radially outwardly.

27. The fishing light of claim 25, wherein each of said plurality of chambers comprises at least one light source.

28. The fishing light of claim 27, wherein each of said plurality of chambers comprises more than one light source.

29. The fishing light of claim 28, wherein each of said plurality of chambers comprise two light sources.

30. The fishing light of claim 29, further comprising means for illuminating a selected number of said light sources.

31. The fishing light of claim 27, further comprising means for illuminating said at least one light source in a particular radially directed chamber.

32. The fishing light of claim 27, wherein said plurality of chambers is disposed so as to direct illumination is a horizontal plane.

33. The fishing light of claim 27, wherein said plurality of chambers are disposed so as to direct illumination below a horizontal plane.

34. The fishing light of claim 27, wherein said radio control signals comprise signals selecting a particular radial direction for illumination and wherein said rotate counterclockwise button and said rotate clockwise button are operably connected to said radio remote control transmitter to provide said signals selecting a particular radial direction for illumination to said radio remote control receiver.

35. The fishing light of claim 29, wherein said radio control signals comprise signals selecting a number of said light sources for providing a desired degree of illumination and wherein said bright/dim mode button is operably connected to said radio remote control transmitter to provide said signals selecting a number of said light sources for providing a desired degree of illumination to said radio remote control receiver.
